(19) United States
(12) Patent Application Publication
(10) Pub. No.: US 2021/0213429 A1
(43) Pub. Date: Jul. 15, 2021

(54) IRON-MAGNESIUM SILICA SUPPORTED CATALYSTS, METHODS OF MAKING AND USES THEREOF

(71) Applicant: SABIC Global Technologies B.V., Bergen op Zoom (NL)

(72) Inventors: Muhammad H. HAIDER, Riyadh (SA); Ahmed S. AL-ZENAIDI, Riyadh (SA)

(73) Assignee: SABIC Global Technologies B.V., Bergen op Zoom (NL)

(21) Appl. No.: 17/250,076

(22) PCT Filed: May 28, 2019
(86) PCT No.: PCT/IB2019/054421

§ 371 Date: Nov. 19, 2020

Related U.S. Application Data
(60) Provisional application No. 62/680,737, filed on Jun. 5, 2018.

(51) Int. Cl. B01J 23/889; C10G 2/00; B01J 23/75; B01J 37/03; B01J 37/04

(52) U.S. Cl. CPC B01J 23/8892; C10G 2/332; B01J 37/04; B01J 37/035; B01J 23/75

(57) ABSTRACT

A catalyst for the production of olefins from synthesis gas, methods of making, uses thereof are described. The catalyst can include a catalytic transition metal on a silica support that includes an iron metal or oxide thereof dispersed throughout a silica-alkaline earth metal oxide support or in the core of the silica alkaline earth metal oxide framework.

### CROSS REFERENCE TO RELATED APPLICATIONS

This application claims the benefit of priority to U.S. Provisional Patent Application No. 62/680,737, filed Jun. 5, 2018, the entire contents of which are hereby incorporated by reference in their entirety.

### BACKGROUND OF THE INVENTION

### A. Field of the Invention

The invention generally concerns a catalyst for the production of olefins from synthesis gas, methods of making, uses thereof. The catalyst can include a catalytic transition metal on, or mixed with, a silica support comprising an alkaline earth metal or oxide thereof, and an iron metal or oxide thereof dispersed throughout the silica.

### B. Description of Related Art

Conventional iron (Fe) and cobalt (Co) based catalysts can have advantages over other transition metal (e.g., nickel, copper, cerium, rhodium, ruthenium, etc.) based catalysts for conversion of synthesis gas (“syngas”) to olefins via a Fischer Tropsch process. Synthesis gas is a mixture of hydrogen (H₂) and carbon monoxide (C), and optional carbon dioxide (CO₂). In this process, carbon monoxide and hydrogen in synthesis gas react over a metal-based catalyst to form olefins as shown in the following reactions:

CO+M→M-CO (CO adsorption); (1)

M-CO→M-C+M-O (CO dissociation); (2)

M-C+[H]→M-CH+[H]→M-CH₂; (H₂ adsorption/methylene formation) (3)

M-CH₂+[H]→M-CH₃→M . . . CH₂—CH₃ (Chain propagation/termination in H₂) (4)

where M is a metal atom of the catalyst, [H] is hydrogen atom of the hydrogen gas in synthesis gas, and CH is an intermediate for a methylene group. The advantages of using a Fischer-Tropsch reaction for production of olefins has been attributed to the easy dissociative adsorption of CO, reasonable hydrogen adsorption, easy reducibility of metal oxide surface species and economically feasible (availability and cost). Further advantages include cobalt being stable for long durations and iron being very active and having high water-gas shift (WGS) activity, which can be required for low hydrogen based feedstocks. However, both catalyst have disadvantages. For example, cobalt based catalysts can have low WGS activity and can produce long straight chain products whereas iron based catalysts can have higher WGS activity and produce short chain products. However iron based catalysts can have a short lifetime due to its strong ability to form carbon deposits leading to deactivation.

To address these disadvantages of Fischer-Tropsch catalysts, promotion of Co with manganese (Mn) and/or Fe have been described. Promotion with Mg can shift the reaction towards a more olefinic product distribution as compared to unpromoted cobalt, while addition of iron can promote higher WGS activity. By way of example, U.S. Pat. No. 9,545,620 to Karim et al. describes a catalyst that includes Co, Mg, Fe, and hydrophillic silica as a binder for the production of olefins from syngas. While this catalyst had high conversion of syngas, it produced undesirable quantities of methane (e.g., greater than 30 mol. %). In another example, Japanese Patent Application No. 2002899634 describes using a silica supported catalyst that includes Fe, Mn, copper and/or Co. In yet another example, U.S. Pat. No. 9,356,038 to Publication No. 103874539 to Bevan et al. describes cobalt and a precious metal impregnated on a magnesia/alumina support material.

While various supported Co, Fe, Mg promoted catalysts are known, these catalyst suffer in high selectivity to carbon dioxide and/or methane and/or involve complicated methodology to prepare.

### SUMMARY OF THE INVENTION

A solution to some of the problems discussed above concerning Fischer-Tropsch conversion of syngas to olefins has been discovered. The solution is premised on catalyst that includes a catalytic transition metal and an iron-alkaline earth metal-silica based support. The iron or oxides thereof and alkaline earth metal or oxides thereof are dispersed throughout the silica matrix support material. This is achieved by producing the silica support in situ (e.g., through co-precipitation methods using tetra-alkyl silicate and iron citrate as a chelating agent). The catalytic transition metal (e.g., Mn, Co, or both) can be deposited on the Fe-alkaline earth metal-silica support. In another example, the catalytic transition metal can be included in catalyst that is physically mixed with the support. The catalyst of the present invention is capable of producing short chain products (e.g., C2-C4 olefinic products) along with high WGS activity and low selectivity towards carbon dioxide production. Without wishing to be bound by theory, it is believed that when the iron is in the support material (e.g., in the core of the framework) it acts as a stabilizer for the in situ generated silica support for longer stability rather than a surface active metal.

In one aspect of the current invention, catalysts capable of producing olefins from synthesis gas are described. A catalyst can include a catalytic transition metal and a silica support can include an alkaline earth metal or oxide thereof, and an iron metal or oxide thereof dispersed throughout the silica (Fe-alkaline earth metal-SiOₓ, where x balances the valence of the catalyst). In some embodiments, the Fe-alkaline earth metal-SiOₓ supported catalyst can include a catalytic transition metal, preferably cobalt, manganese, or both. The alkaline earth metal can include magnesium, calcium, strontium, barium or mixtures thereof, preferably magnesium. In certain embodiments, the catalyst is absent a lanthanide, phosphorous or compound thereof, or combinations thereof. In some embodiments, the silica is not fumed silica. In some instances, the molar ratio of alkaline earth metal to silicon is 0.05 to 3. The catalytic transition metal can be deposited on the Fe-alkaline earth metal-SiOₓ support. In other instances, the catalytic transition metal can be included in a calcined catalyst that is physically mixed with the Fe-alkaline earth metal-SiOₓ support. By way of example, a catalytic transition metal supported on fumed silica.

In another aspect of the invention, methods for preparing the catalyst of the present invention are described. A method can include the steps of: (a) obtaining a solution of a silicon precursor material (e.g., tetra-alkyl silicate such as tetraethyl orthosilicate (TEOS), an alkaline earth metal precursor material, and an iron chelated material (e.g., iron citrate); (b) adding an alkaline solution to the step (a) solution to precipitate a silica/alkaline-earth metal/iron material; (c) contacting the precipitated material with an oxidizing agent (e.g., hydrogen peroxide (H₂O₂) to remove the chelating material (e.g., citrate); (d) heat treating (e.g., drying) the precipitating material to produce an Fe-alkaline earth metal-silica support material, wherein the iron and alkaline earth metal are dispersed throughout the silica; and contacting the Fe-alkaline earth metal-silica support material with a catalytic transition metal solution or mixing the Fe-alkaline earth metal-silica support material with a supported catalyst comprising a catalytic transition metal. The alkaline earth metal precursor material comprising magnesium, calcium, strontium, barium, or combinations thereof, preferably a magnesium salt. Prior to step (c) the precipitated material can be dried at a temperature of 100 C to 150° C., preferably 130° C. Step (b) precipitation can include adding an alkaline solution comprising ammonia, preferably ammonium hydroxide to the solution. The oxidizing solution in step (c) can be hydrogen peroxide (H₂O₂). The step (b) material can be isolated and dried at 100 C to 150° C., preferably 130° C. and then calcined at a temperature of 300° C. to 550° C., preferably 450° C.

In yet another aspect of the present invention, methods of producing olefins from synthesis gas are described. A method can include contacting a reactant feed that includes hydrogen (H₂) and carbon monoxide (CO) with the catalyst(s) of the present invention, or made by the methods of the present invention, under conditions sufficient to produce an olefin. Conditions can include temperature (e.g., 230° C. to 400° C., preferably, 240° C. to 350° C.), weighted hourly space velocity (WHSV) (e.g., 1000 h⁻¹ to 3000 h⁻¹, preferably 1500 h⁻¹ to 2000 h⁻¹), pressure (e.g., 0.1 MPa to 1 MPa), or combinations thereof. A molar ratio of H₂ to CO can be 1:1 to 10:1, preferably 2:1. The olefin selectivity of the catalyst can be at least 15 mol. %, preferably 20 mol. %, CO₂ selectivity of less than 25 mol %, a methane selectivity of less than 20 mol. %, preferably less than 20 mol. %, more preferably less than 10 mol. %, or combinations thereof.

The following includes definitions of various terms and phrases used throughout this specification.

An alkyl group is linear or branched, substituted or substituted, saturated hydrocarbon. Non-limiting examples of alkyl group substituents include alkyl, halogen, hydroxyl, alkyloxy, haloalkyl, haloalkoxy, carboxylic acid, ester, amine, amide, nitrile, acyl, thiol and thioether.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %”, “vol. %”, or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of the catalysts of the present invention are their abilities to catalyze production of olefins from synthesis gas.

In the context of the present invention at least twenty embodiments are now described. Embodiment 1 is a catalyst for the production of olefins from synthesis gas. The catalyst includes a catalytic transition metal deposited on, or mixed with, a silica support having an alkaline earth metal or oxide thereof, and an iron metal or oxide thereof dispersed throughout the silica. The catalyst of embodiment 1, wherein the catalytic transition metal comprises cobalt, manganese, or both. Embodiment 2 is the catalyst of embodiment 1, wherein the catalytic transition metal contains cobalt, manganese, or both. Embodiment 3 is the catalyst of any one of embodiments 1 to 2, wherein the alkaline earth metal includes magnesium, calcium, strontium, barium or mixtures thereof. Embodiment 4 is the catalyst of any one of embodiments 1 to 4, wherein the catalytic transition metal is deposited on the silica support. Embodiment 5 is the catalyst of any one of embodiments 1 to 6, wherein the silica is not fumed silica. Embodiment 6 is the catalyst of embodiment 1, wherein the catalytic transition metal is mixed with the iron-magnesia-silica support material, and the catalytic transition metal is included in a calcined catalyst containing manganese and cobalt metals or oxides thereof deposited on a fumed silica support. Embodiment is the catalyst of any one of embodiments 1 to 6, wherein the molar ratio of alkaline earth metal to silicon is 0.05 to 3. Embodiment 8 is the catalyst of any one of embodiments 6 to 7, wherein the step (a) catalyst further includes sodium.

Embodiment 9 is a method of making the catalyst. The method includes the steps of obtaining a solution of a silicon precursor material, an alkaline earth metal precursor material and an iron precursor material; adding an alkaline solution to the step (a) solution to precipitate a silica/alkaline-earth metal/iron material; contacting the precipitated material with an oxidizing agent to remove the precursor material; heat treating the precipitating material to produce an Fe-alkaline earth metal-silica support material, wherein the iron and alkaline earth metal are dispersed throughout the silica; and contacting the Fe-alkaline earth metal-silica support material with a catalytic transition metal solution or mixing the Fe-alkaline earth metal-silica support material with a supported catalyst comprising cobalt/manganese. Embodiment 10 is the method of embodiment 9, wherein the Fe-alkaline earth metal-silica support material is contacted with a catalytic transition metal solution. Embodiment 11 is the method of embodiment 9, wherein the Fe-alkaline earth metal-silica support material is mixed with a supported catalyst containing cobalt/manganese. Embodiment 12 is the method of any one of embodiments 9 to 11, wherein the iron precursor material is iron citrate. Embodiment 13 is the method of any one of embodiments 9 to 12, wherein the alkaline earth metal precursor material contains magnesium, calcium, strontium, barium, or combinations thereof, preferably a magnesium salt. Embodiment 14 is the method of any one of embodiments 9 to 13, further including the step of isolating and drying the step (b) precipitated material at a temperature of 100° C. to 150° C., preferably 130° C. prior to step (c). Embodiment 15 is the method of any one of embodiments 9 to 14, further including the step of isolating and drying the material of step (c) at 100 C to 150° C., preferably 130° C. Embodiment 16 is the method of embodiment 15, further including the step of calcining the dried material at 300° C. to 550° C., preferably 450° C. Embodiment 17 is the method of any one of embodiments 9 to 16, wherein step (b) includes adding an alkaline solution comprising ammonia, preferably ammonia hydroxide to the solution, the oxidizing solution in step (c) is hydrogen peroxide (H₂O₂), or both.

Embodiment 18 is a method of producing olefins from synthesis gas. The method includes the steps of contacting a reactant feed comprising hydrogen (H₂) and carbon monoxide (CO) with the catalyst of any one of embodiments 1-8 or made by the method of any one of embodiments 9 to 17, under conditions sufficient to produce an olefin. Embodiment 19 is the method of embodiment 18, wherein the catalyst is capable of producing olefins from syngas with a CO2 selectivity of less than 25 mol %, a methane selectivity of less than 20 mol. %, preferably less than 20 mol. %, more preferably less than 10 mol. %, an olefin selectivity of at least 15 mol. %, preferably 20 mol. %, or combinations thereof. Embodiment 20 is the method of any one of embodiments 18 to 19, wherein the conditions include a temperature from 230° C. to 400° C., preferably, 240° C. to 350° C., a weighted hourly space velocity of 1000 h⁻¹ to 3000 h⁻¹, preferably 1500 h⁻¹ to 2000 h⁻¹, a pressure of 0.1 MPa to 1 MPa, or combinations thereof.

Other objects, features and advantages of the present invention will become apparent from the detailed description, and examples. It should be understood, however, that the detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein. It is contemplated that any embodiment discussed herein can be implemented with respect to any method or composition of the invention, and vice versa. Furthermore, compositions of the invention can be used to achieve methods of the invention.

### DETAILED DESCRIPTION OF THE INVENTION

A discovery has been made that provides a solution to problems associated with catalysts used in the Fisher-Tropsch process to produce olefins from syngas. The discovery is premised on using a catalyst that includes a catalytic transition metal and a silica support having iron or an oxide thereof and an alkaline earth metal or oxide thereof dispersed throughout the silica support. Non-limiting examples of the catalytic transition metal are Co, Mn, Rh, Ru, and combinations thereof. Preferably, cobalt and manganese are used. Further, the catalytic activity and stability for the catalyst of the present invention is comparable or better as compared to the conventional catalysts for the Fischer-Tropsch process. Therefore, the catalyst of the present invention provides a technical solution to at least some of the problems associated with the currently available catalysts for the Fischer-Tropsch process mentioned above, such as low selectivity, low catalytic activity, and/or low stability.

These and other non-limiting aspects of the present invention are discussed in further detail in the following sections.

### A. Catalysts of the Present Invention

The catalyst of the present invention can be a supported catalyst or a physical mixture of a supported catalyst with an iron-stabilized alkaline earth metal-silica support. Non-limiting examples of alkaline earth metals (Column 2 of the Periodic Table) include Mg, Ca, Sr, Ba and combinations thereof. Non-limiting examples of catalytic transition metals (Columns 5-12 of the Periodic Table include Mn, Co, Rh, chromium (Cr), molybdenum (Mo), tungsten (W), nickel (Ni), palladium (Pd), copper (Cu), silver (Ag), zinc (Zn), cadmium (Cd), oxides thereof, alloys thereof and mixtures thereof. The Fe-alkaline metal-silica support can include at least, equal to or between any two of 1, 2, 3, and 4 wt. % of iron and at least, equal to or between any two of 15, 20, 25, 30, and 35 wt. % alkaline earth metal with the balance being silicon and oxygen. The catalyst of the present invention (Fe-alkaline metal-silica supported catalyst or physical mixture) can include up to 20 wt. % of the total amount of total catalytic transition metal, from 0.001 wt. % to 20 wt. %, from 0.01 wt. % to 15 wt. %, or from 1 wt. % to 10 wt. % and all wt. % or at least, equal to, or between any two of 0.001 wt. %, 0.01 wt. %, 0.1 wt. %, 1 wt. %, 2 wt. %, 3 wt. %, 4 wt. %, 5 wt. %, 6 wt. %, 7 wt. %, 8 wt. %, 9 wt. %, 10 wt. %, 15 wt. %, and 40 wt. %, with the balance support.

In some embodiments, the catalyst includes cobalt and manganese. The molar ratio of cobalt to manganese in Fe-alkaline metal-silica supported catalyst or physical mixture can be range of 0.05 to 3 and all ranges and values there between including 0.05 to 0.10, 0.10 to 0.20, 0.20 to 0.40, 0.40 to 0.60, 0.60 to 0.80, 0.80 to 1.0, 1.0 to 1.2, 1.2 to 1.4, 1.4 to 1.6, 1.6 to 1.8, 1.8 to 2.0, 2.0 to 2.2, 2.2 to 2.4, 2.4 to 2.6, 2.6 to 2.8, and 2.8 to 3.0. A weight ratio of active metal (cobalt and manganese) to silica (SiO) may be in a range of 0.05 to 5 and all ranges and values there between including 0.05 to 0.10, 0.10 to 0.20, 0.20 to 0.40, 0.40 to 0.60, 0.60 to 0.80, 0.80 to 1.0, 1.0 to 1.2, 1.2 to 1.4, 1.4 to 1.6, 1.6 to 1.8, 1.8 to 2.0, 2.0 to 2.2, 2.2 to 2.4, 2.4 to 2.6, 2.6 to 2.8, 2.8 to 3.0, 3.0 to 3.2, 3.2 to 3.4, 3.4 to 3.6, 3.6 to 3.8, 3.8 to 4.0, 4.0 to 4.2, 4.2 to 4.4, 4.4 to 4.6, 4.6 to 4.8, and 4.8 to 5.0. Overall, the active catalyst may have a composition of 3 to 20 wt. % manganese, 0.05 to 8 wt. % cobalt, 40 to 80 wt. % silica, and 0.05 to 8 wt. % iron. Stability of the active catalyst can be quantified at a conversion rate of 30 to 90 over 100 hours under a temperature of 240 to 350° C.

### B. Preparation of the Catalysts of the Present Invention

The Fe-alkaline metal-silica support of the present invention are made co-precipitation methodology. The method is such that the alkaline earth metal-silicates are first introduced into an aqueous media in the form of sol, which has certain dimensions in terms of water ligands, alkaline earth metal and silica portion. The iron chelated precursor, which acts as a chelating agent in the the silica-alkaline earth metal sol, can then be added. The support material can be precipitating from solution using alkaline solution, washed and dried. The dried material can be washed with an oxidizing solution to remove the chelating agent (e.g., citrate) and then dried. The catalytic transition metal can be precipitated or co-precipitated onto the dried support material. In some embodiments, a alkaline precipitating agent (e.g., sodium carbonate) is added to the solution and can be removed by washing the resulting precipitate during isolation. The resulting precipitate can be isolated, dried and calcined to form a catalytic transition metal on a Fe-alkaline metal-silica support. The resulting catalyst includes a catalytic transition metal species decorated onto a porous support with iron core surrounded by hierarchy of silicon and alkaline-earth metal (e.g., Mg) oxide. This methodology is in contrast to methods using hydrophilic silica (fumed silica) as a support. In other instances, the dried Fe-alkaline metal-silica support can be physically mixed with a calcined catalyst that includes the catalytic transition metal and a silica support. This support of this catalyst can be any type of silica.

According to embodiments of the invention, a method may include providing an alkaline earth metal precursor solution. Non-limiting examples of the alkaline earth metal precursors may include magnesium chloride, magnesium acetate, calcium chloride, strontium chloride, strontium acetate, barium chloride, barium acetate, and combinations thereof. The solution can water. The alkaline earth metal salt solution may have a concentration in a range of 0.1 to 5 M and all ranges and values there between including 0.1 to 0.2 M, 0.2 to 0.4 M, 0.4 to 0.6 M, 0.6 to 0.8 M, 0.8 to 1.0 M, 1.0 to 1.2 M, 1.2 to 1.4 M, 1.4 to 1.6 M, 1.6 to 1.8 M, 1.8 to 2.0 M, 2.0 to 2.2 M, 2.2 to 2.4 M, 2.4 to 2.6 M, 2.6 to 2.8 M, 2.8 to 3.0 M, 3.0 to 3.2 M, 3.2 to 3.4 M, 3.4 to 3.6 M, 3.6 to 3.8 M, 3.8 to 4.0 M, 4.0 to 4.2 M, 4.2 to 4.4 M, 4.4 to 4.6 M, 4.6 to 4.8 M, and 4.8 to 5.0 M. In embodiments of the invention, the alkaline metal salt solution may be continuously stirred under a temperature in a range of 45° C. to 90° C. and all ranges and values there between. The duration for stirring may be in a range of 1 to 5 hours and all ranges and values there between.

A silica precursor material can be added to the alkaline earth metal solution. In some embodiments, the silica precursor material is added slowly (e.g., dropwise over time). Non-limiting examples of silica precursor material includes tetra-alkyl silicate, diethoxydimethylsilane (DEMS), tetramethyl orthosilicate (TMOS), tetraethyl orthosilicate (TEOS), and combinations thereof. In embodiments of the invention, the tetra-alkyl silicate can be TEOS. According to embodiments of the invention, the first mixture may have a alkaline earth metal to silicon weight (e.g., Mg:Si) ratio of 0.05 to 3 and all ranges and values there between including 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0.

A precipitating agent can be added to the first mixture to form a second mixture. A non-limiting example of the precipitating agent may include ammonia or ammonia hydroxide (e.g., 1 to 8 M, or 1, 2, 3, 4, 5, 6, 7, and 8 M). In embodiments of the invention, the amount of the precipitating agent added to the first mixture may be in a range of 45 to 100 mL, or and all ranges and values there between, including 45, 50, 55, 60, 65, 70, 75, 80, 85, 90, 95 and 100 mL. The second mixture may be continuously stirred for a duration of 0.5 to 5 hrs including 1, hrs, 2 hrs, 3 hrs, 4 hrs, and 5 hrs at a temperature of 20 to 30° C., or about 25° C. until a gel is obtained. The composition of the second mixture can include 25 wt. % magnesium, 1 wt. % iron, and 74 wt. % silica.

The gel from the second mixture can be isolated (e.g., filtered or centrifuged), washed with hot water to remove the ammonia, and dried. Drying temperatures can range from 100 to 150° C. and all values and ranges there between including 100 to 105° C., 105 to 110° C., 110 to 115° C., 115 to 120° C., 120 to 125° C., 125 to 130° C., 130 to 135° C., 135 to 140° C., 140 to 145° C., and 145 to 150° C. The drying process may be 5 to 12 hrs and all ranges and values there between including 6 hrs, 7 hrs, 8 hrs, 9 hrs, 10 hrs, 11 hrs. The dried gel can be contacted with an oxidizing solution (e.g., 50 mL of 10% H₂O₂). In some embodiments, contacting includes immersing the dried gel in an oxidizing solution. Contacting the dried gel with the oxidizing solution removes the remaining chelating material(s) and provides a solid material having iron and alkaline earth metal dispersed throughout the solid.

The dried Fe-alkaline earth metal-SiO material can be co-precipitated with the catalytic transition metal precursor. The dried Fe-alkaline earth metal-SiOₓ material can be dispersed in a solvent (e.g., water) and agitated at a temperature of 25 to 100° C., 50 to 80° C., or all values and ranges there between to form an aqueous dispersion. Agitation can range for 0.5 hours to 5 hours, or 1 to 3 hours or any values or ranges there between. A catalytic transition metal precursor solution can be added to the aqueous dispersion. One or more catalytic transition metal precursor solutions can be prepared by adding a catalytic transition metal salt (e.g., a halide, nitrate, acetate, oxides, hydroxide, etc.). Non-limiting examples of the precursor solutions include an aqueous cobalt solution and an aqueous manganese solution. A basic solution (e.g., a solution of sodium carbonate) can also be prepared. The catalytic transition metal precursor solution(s) and the basic solution can be added to the aqueous dispersed support over time (e.g., dropwise). The metal precursors precipitate onto the solid support and form a catalytic transition metal/support material. This dispersion can be agitated at for 0.5 hours to 5 hours, or 1 to 3 hours or any values or ranges there between at 25 to 100° C., 50 to 80° C., or all values and ranges there between to form an aqueous dispersion. The precipitated catalytic transition metal/support material can be isolated (e.g., centrifuged or filtered), dried, and then calcined. Drying temperatures can range from 100 to 150° C. and all values and ranges there between including 100 to 105° C., 105 to 110° C., 110 to 115° C., 115 to 120° C., 120 to 125° C., 125 to 130° C., 130 to 135° C., 135 to 140° C., 140 to 145° C., and 145 to 150° C. The drying process may be 5 to 12 hrs and all ranges and values there between including 6 hrs, 7 hrs, 8 hrs, 9 hrs, 10 hrs, 11 hrs.

The supported catalyst of the present invention can be calcined at a temperature of 350 to 600° C. and all ranges and values there between including 350 to 360° C., 360 to 370° C., 370 to 380° C., 380 to 390° C., 390 to 400° C., 400 to 410° C., 410 to 420° C., 420 to 430° C., 430 to 440° C., 440 to 450° C., 450 to 460° C., 460 to 470° C., 470 to 480° C., 480 to 490° C., 490 to 500° C., 500 to 510° C., 510 to 520° C., 520 to 530° C., 530 to 540° C., 540 to 550° C., 550 to 560° C., 560 to 570° C., 570 to 580° C., 580 to 590° C., 590 to 600° C. to produce the catalytic transition metal catalyst deposited on the Fe-alkaline earth metal silica support of the present invention. A heating rate for the calcination may be in a range of 1 to 5° C./min and all ranges and values there between including 2° C./min, 3° C./min, and 4° C./min. A calcination duration may be in a range of 2 to 12 hrs and all ranges and values there between including 3 hrs, 4 hrs, 5 hrs, 6 hrs, 7 hrs, 8 hrs, 9 hrs, 10 hrs, and 11 hrs.

The dried Fe-alkaline earth metal-SiOₓ material can be physically mixed with a calcined catalyst that includes the catalytic transition metal. The mixture can include 1 to 2 g of the dried Fe-alkaline earth metal-SiOₓ material and 5 to 6 g of the calcined catalyst, or a weight ratio of dried Fe-alkaline earth metal-SiOₓ material to calcined of 0.15:1 to 0.5:1, or 0.16:1 to 0.33. The calcined catalyst can include a fumed (hydrophilic) support material that is absent iron. Non-limiting examples of a calcined catalyst include a Co/SiO₂ catalyst, a CoMn/SiO₂ catalyst and the like.

The catalyst of the present invention can be further processed into a shaped form using known pelletizing, tableting procedures.

C. Method of Producing Olefins from a Reactant Feed that includes H₂ and CO.

The active catalyst of the present invention can catalyze the conversion of a reactant feed that includes H₂ and CO (e.g., synthesis gas) to produce olefins. Olefins can include olefins having 2, 3, 4, and 5 carbon atoms. For example, C2 to C4 olefins includes hydrocarbons that include 2, 3, 4 carbon atoms. Non-limiting examples of olefins include acetylene, propene, 1-butene, isobutylene, isoprene, and the like.

In embodiments of the invention, the synthesis gas can include 60 to 72 vol. % hydrogen and 28 to 40 vol. % carbon monoxide. In some embodiments, the molar ratio of H₂ to CO can be 1:1 to 10:1, or at least, equal to, or between any two of 1:1, 2:1, 3:1, 4:1, 5:1, 6:1, 7:1, 8:1, 9:1, and 10:1. The reaction conditions can include temperature, pressure and WHSV. The reaction temperature in a range of 240 to 400° C. and all ranges and values there between including 240 to 250° C., 250 to 260° C., 260 to 270° C., 270 to 280° C., 280 to 290° C., 290 to 300° C., 300 to 310° C., 310 to 320° C., 320 to 330° C., 330 to 340° C., 340 to 350° C., 350 to 360° C., 360 to 370° C., 370 to 380° C., 380 to 390° C., and 390 to 400° C. The reaction conditions can include a reaction pressure in a range of 0.1 to 1.0 MPa and all ranges and values there between including 0.2, 0.3, 0.4, 0.5, 0.6, 0.7, 0.8 and 0.9 MPa. In embodiments of the invention, a weight hourly space velocity for the synthesis gas can a range of 1200 to 2500 hr⁻¹, and all ranges and values there between 1200 to 1300 hr⁻¹, 1300 to 1400 hr⁻¹, 1400 to 1500 hr⁻¹, 1500 to 1600 hr⁻¹, 1600 to 1700 hr⁻¹, 1700 to 1800 hr⁻¹, 1800 to 1900 hr⁻¹, 1900 to 2000 hr⁻¹, 2000 to 2100 hr⁻¹, 2100 to 2200 hr⁻¹, 2200 to 2300 hr⁻¹, 2300 to 2400 hr⁻¹, and 2400 to 2500 hr⁻¹. Contact of the reactant gas feed with the catalyst produces a product stream that includes olefins, C2+ paraffins, methane, and carbon dioxide (CO₂) can also be formed. The olefins can include C2 to C4 olefins. The product stream can be separated to produce a C2-C4 olefins stream and a by-product stream. The by-product stream can include paraffins, higher olefins (C5+ olefins), methane, and CO₂. Separation methods include distillation, membrane separations and the like, which are known in the art.

A conversion rate of the synthesis gas can be at least 30 to 100%, or at least, equal to, or between any two of 30%, 35%, 40%, 50%, 55%, 60%, 65%, 70%, 75%, 80%, 85%, 90%, 95% and 100%. Olefins selectivity can range from 10 to 100%, or at least, equal to, or between any two of 10, 15, 20, 25, 30, 35, 40, 45, 50, 55, 60, 65, 70, 75, 80, 85, 90, and 100%. C2 to C4 olefins selectivity can range from 10 to 100, or at least, equal to, or between any two of 10, 15, 20, 25, 30, 35, 40, 45, 50, 55, 60, 65, 70, 75, 80, 85, 90, and 100%. CO₂ selectivity can be less than, equal to, or between any two 25%, 20%, 15%, 10%, The methane selectivity can be less than, equal to, or between any two of 30%, 25%, 20%, 15%, 10%, 5%, 1%, and 0%. In some instances, the olefins selectivity at 240° C. is at least 30%, with the selectivity to C2 to C4 olefins being 20% and the methane and CO₂ selectivity being less than 15% after 10 hours on stream.

The method can also include activating the catalyst prior to contact with the reactant feed. To activate the catalyst a gas stream including a reducing agent (e.g., hydrogen) and a chemically inert gas (e.g., nitrogen) can be contacted with the catalyst (e.g., flow through the catalyst bed) at a temperature of 300 to 350° C. and all ranges and values there between. A molar ratio for reducing gas to inert gas in the gas stream can be about 1:1. A heating rate for the activation may be in a range of 2 to 5° C./min and all ranges and values there between including 3° C./min and 4° C./min. A weight hourly space velocity for the gas stream containing the reducing gas may be in a range of 3200 to 4000 hr⁻¹ and all ranges and values there between including 3200 to 3250 hr⁻¹, 3250 to 3300 hr⁻¹, 3300 to 3350 hr⁻¹, 3350 to 3400 hr⁻¹, 3400 to 3450 hr⁻¹, 3450 to 3500 hr⁻¹, 3500 to 3550 hr⁻¹, 3550 to 3600 hr⁻¹, 3600 to 3650 hr⁻¹, 3650 to 3700 hr⁻¹, 3700 to 3750 hr⁻¹, 3750 to 3800 hr⁻¹, 3800 to 3850 hr⁻¹, 3850 to 3900 hr⁻¹, 3900 to 3950 hr⁻¹, and 3950 to 4000 hr⁻¹.

In embodiments of the invention, an apparatus can be adapted for conversion of synthesis gas to C2 to C4 olefins using the aforementioned active catalyst. The apparatus can include a fixed-bed flow reactor. The apparatus can include a catalyst bed in a fixed-bed flow reactor. The apparatus can also include a housing for containing the catalyst bed. In some embodiments the apparatus can include inlet means for introducing synthesis gas to the catalyst bed. The inlet means can an entrance adapted to receive synthesis gas. Further the apparatus can include an outlet means for removing the product stream that includes C2 to C4 olefins from the apparatus. The outlet means can include an exit adapted to flow the product stream from the housing. In embodiments of the invention, the apparatus can include the catalyst according to embodiments of the invention disposed in the catalyst bed. According to embodiments of the invention, the apparatus may be a fluidized bed reactor, and/or a slurry reactor.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Materials Used

The following lab grade chemicals were obtained from SigmaMillipore without further purification: fumed silica (Aerosil 200V, Evonik Industries, Germany), Magnesium chloride (1M soln.), Tetraethyl orthosilicate (TEOS), Ferric citrate, liquid ammonia, hydrogen peroxide, Manganese (II) nitrate tetra hydrate (>97% purity), Cobalt (II) nitrate hexahydrate (>98% purity).

### Example 1

### Synthesis of Comparative CoMn/Fumed SiO₂ Catalyst

Silica (1.2 g) was suspended in demineralized (DM) water (100 mL) and stirred for an hour at 70° C. Two solutions, Co salt (14.55 g) and Mn (12.55 g) were mixed together in 100 ml deionized (DI) H2O at 70° C. A sodium carbonate solution (1M) was prepared. These solutions were added simultaneously to silica solution until complete precipitates formed. The resulting mixture was aged for 30 min under stirring before washing with hot water followed by drying overnight at 130° C. and calcination in static air at 500° C. (4 h, 5° C./min). The catalyst is denoted by the symbol “A” hereafter.

### Example 2

### Synthesis of CoMn/FeMgSiO Support

Magnesium chloride (50 ml of the 1 M solution) was diluted with deionized H₂O (to 100 mL) and stirred vigorously at 50° C. Afterwards, TEOS (10.4 g) was dropped into it. Then, ferric citrate crystals (0.25 g) were added and continued to stir for 2 h. At this stage, NH₄OH (7 M, 50 ml stock up to 100 mL total) was added to the solution and the solution stirred for another 2 h before filtration to complete precipitation and then washed with hot water. The obtained material was dried overnight and then immersed in hydrogen peroxide (15% 50 ml) for 1 h. After drying the support material for 4 h, of the dried support material (1.2 g) was suspended in DM water (100 mL) and stirred for an hour at 70° C. Two solutions, Co salt (14.55 g) and Mn (12.55 g) were mixed together in deionized H2O (100 mL) and stirred at 70° C. A sodium carbonate solution (1 M) was prepared. These solutions were added simultaneously to support mixture until complete precipitates formed. The resulting mixture was aged for 30 min under stirring before washing with hot water followed by drying overnight at 130° C. and calcination in static air at 500° C. (4 h, 5° C./min). The catalyst was denoted by the symbol “B” hereafter.

### Example 3

### Preparation of a Mixed Calcined Catalyst with FeMgSiO Support

Fumed silica (1.2 g) was suspended in DM water (100 mL) and stirred for an hour at 70° C. Two solutions, Co salt (14.55 g) and Mn (12.55 g) were mixed together in deionized H2O (100 mL) and stirred at 70° C. A sodium carbonate solution (1 M) was prepared. These solutions were added simultaneously to the fumed silica solution until complete precipitates formed. The resulting mixture was aged for 30 min under stirring before washing with hot water followed by drying overnight at 130° C. and calcination in static air at 500° C. (4 h, 5° C./min). This material was then physically mixed with the support (prepared in the above example) in ethanol solvent before oven drying and pelleting for evaluation. The catalyst was denoted by the symbol “C” hereafter.

### Example 4

### Synthesis of CoMn/FeMgSiO Catalyst

Magnesium chloride (20 ml of 1 M diluted to 100 mL with deionized H2O) was stirred vigorously at 50° C. TEOS (21 g) was added to the aqueous MgCl solution. Then, ferric citrate crystals (0.25 g) were added and continued to stir for 2 h. At this stage, NH₄OH (1 M, 7 mL stock up to 100 mL total) was added to the solution and the solution stirred for another 2 h before filtration to complete precipitation and then washed with hot water. The obtained material was dried overnight and then immersed in hydrogen peroxide (15% 50 ml) for 1 h. After drying the support material for 4 h, of the dried support material (1.2 g) was suspended in DM water (100 mL) and stirred for an hour at 70° C. Two solutions, Co salt (14.55 g) and Mn (12.55 g) were mixed together in deionized H2O (100 mL) and stirred at 70° C. A sodium carbonate solution (1 M) was prepared. These solutions were added simultaneously to support mixture until complete precipitates formed. The resulting mixture was aged for 30 min under stirring before washing with hot water followed by drying overnight at 130° C. and calcination in static air at 500° C. (4 h, 5° C./min). The catalyst was denoted by the symbol “D” hereafter.

### Example 5

### Preparation of a Mixed Calcined Catalyst with FeMgSiO Support

A catalyst prepared using the method of Example 3. This material was then physically mixed with a portion of the FeMgSiO support prepared from Example 4 (1.2 g) in ethanol solvent before oven drying and pelleting for evaluation. The catalyst was denoted by the symbol “E” hereafter.

### Example 6

### Preparation of a Mixed Calcined Catalyst with FeMgSiO Support

Magnesium chloride (30 ml of 1 M diluted to 100 mL with deionized H2O) was stirred vigorously at 50° C. TEOS (10.4 g) was added to the aqueous MgCl solution. Then, ferric citrate crystals (0.25 g) were added and continued to stir for 2 h. At this stage, NH₄OH (7 M, 50 mL stock up to 100 mL total) was added to the solution and the solution stirred for another 2 h before filtration to complete precipitation and then washed with hot water. The obtained material was dried overnight and then immersed in hydrogen peroxide (15% 50 ml) for 1 h. This material was dried for 4 hours.

A CoMnSiO catalyst was prepared using the method of Example 1. This material was then physically mixed with the prepared support (1.2 g) in ethanol solvent before oven drying and pelleting for evaluation. The catalyst was denoted by the symbol “F” hereafter.

### Example 7

### Catalyst Activity/Selectivity Evaluation

The catalysts from Examples 1-6 were evaluated for the activity and selectivity for the production of C2-C4 olefins in a fixed bed flow reactor setup housed in temperature controlled system fitted with regulators to maintain pressure during the reaction. Prior to activity measurement, all of the catalysts were subjected to activation/reduction procedure which was performed at 350° C. with the ramp rate of 3° C. min⁻¹ for 16 h in 50:50 H₂/N₂ flow (WHSV: 3600 h⁻¹). The products of the reactions were analyzed through online GC analysis using an Agilent GC (Agilent Scientific Instruments, U.S.A.) with a capillary column equipped with TCD and FID detectors. The catalytic evaluation was carried out under the following conditions unless otherwise mentioned elsewhere; catalyst 0.5 g, temperatures 240° C., WHSV 2500 h⁻¹, H₂/CO molar ratio was 2, time on stream for each run: 100 h and under pressure of 5 bar. The mass balance of the reactions is calculated to be 100%±5.

The catalysts of Examples 2-6 the present invention utilized cobalt and manganese as an active phase supported onto silica. The product distribution over the active phase was improved by careful design of solid support material used in the experiments. Support material was applied either by co-precipitation or physical mixing during catalyst preparation. Example “A” in the results (Table 1) represents the comparative catalyst prepared by using commercial silica giving high amounts of unwanted carbon dioxide. From the data, it was found that modification of the catalyst with a fine-tuned support material of the present invention through physical mixture improved the olefins selectivity as well as decreasing the carbon dioxide produced during the reaction (see Table 1, example “B”). A further improvement in selectivity of short chain olefins was achieved as shown in example “E”. This showed minimal activity towards methane and carbon dioxide at a per pass conversion of ca. 50%. The results are tabulated in Table 1 below.

TABLE 1

| Catalysts | A* | B | C | D | E | F |
|---|---|---|---|---|---|---|
| Conversion (mol. %) | 65 | 60 | 77 | 65 | 52 | 53 |
| | Selectivities (mol. %) | | | | | |
| Olefins | 32 | 40 | 16 | 28 | 50 | 42 |
| Olefins (C2-C4) | 17 | 22 | 8 | 16 | 33 | 22 |
| Paraffins | 26 | 27 | 40 | 18 | 26 | 30 |
| Methane | 6 | 8 | 12 | 5 | 11 | 8 |
| CO₂ | 26 | 12 | 24 | 36 | 10 | 9 |
| Alcohols | 10 | 13 | 7 | 13 | 3 | 10 |

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A catalyst for the production of olefins from synthesis gas, the catalyst comprising a catalytic transition metal deposited on, or mixed with, a silica support comprising an alkaline earth metal or oxide thereof, and an iron metal or oxide thereof dispersed throughout the silica.

2. The catalyst of claim 1, wherein the catalytic transition metal comprises cobalt, manganese, or both.

3. The catalyst of claim 1, wherein the alkaline earth metal comprises, magnesium, calcium, strontium, barium or mixtures thereof.

4. The catalyst of claim 1, wherein the catalytic transition metal is deposited on the silica support.

5. The catalyst of claim 1, wherein the silica is not fumed silica.

6. The catalyst of claim 1, wherein the catalytic transition metal is mixed with the iron-magnesia-silica support material, and the catalytic transition metal is comprised in a calcined catalyst comprising manganese and cobalt metals or oxides thereof deposited on a fumed silica support.

7. The catalyst of claim 1, wherein the molar ratio of alkaline earth metal to silicon is 0.05 to 3.

8. The catalyst of claim 6, wherein the step (a) catalyst further comprises sodium.

9. A method of making the catalyst, the method comprising:
obtaining a solution of a silicon precursor material, an alkaline earth metal precursor material and an iron precursor material;
adding an alkaline solution to the step (a) solution to precipitate a silica/alkaline-earth metal/iron material;
contacting the precipitated material with an oxidizing agent to remove the precursor material;
heat treating the precipitating material to produce an Fe-alkaline earth metal-silica support material, wherein the iron and alkaline earth metal are dispersed throughout the silica; and
contacting the Fe-alkaline earth metal-silica support material with a catalytic transition metal solution or mixing the Fe-alkaline earth metal-silica support material with a supported catalyst comprising cobalt/manganese.

10. The method of claim 9, wherein the Fe-alkaline earth metal-silica support material is contacted with a catalytic transition metal solution.

11. The method of claim 9, wherein the Fe-alkaline earth metal-silica support material is mixed with a supported catalyst comprising cobalt/manganese.

12. The method of claim 9, wherein the iron precursor material is iron citrate.

13. The method of claim 9, wherein the alkaline earth metal precursor material comprising magnesium, calcium, strontium, barium, or combinations thereof, preferably a magnesium salt.

14. The method of claim 9, further comprising isolating and drying the step (b) precipitated material at a temperature of 100° C. to 150° C. prior to step (c).

15. The method of claim 9, 11 further comprising isolating and drying the material of step (c) at 100 C to 150° C.

16. The method of claim 15, further comprising calcining the dried material at 300° C. to 550° C.

17. The method of claim 9, wherein step (b) comprises adding an alkaline solution comprising ammonia to the solution, the oxidizing solution in step (c) is hydrogen peroxide (H₂O₂), or both.

18. A method of producing olefins from synthesis gas, the method comprising contacting a reactant feed comprising hydrogen (H₂) and carbon monoxide (CO) with the catalyst of claim 1, under conditions sufficient to produce an olefin.

19. The method of claim 18, wherein the catalyst is capable of producing olefins from syngas with a CO₂ selectivity of less than 25 mol % and a methane selectivity of less than 20 mol. %.

20. The method of claim 18, wherein the conditions comprise a temperature from 230° C. to 400° C., a weighted hourly space velocity of 1000 h⁻¹ to 3000 h⁻¹, a pressure of 0.1 MPa to 1 MPa, or combinations thereof.
